(19) United States
(12) Patent Application Publication
(10) Pub. No.: US 2004/0187462 A1
(43) Pub. Date: Sep. 30, 2004

(54) Pruning device for removing branches from living trees

(76) Inventor: Ernst Jordan, Neustadt (DE)

Correspondence Address: WILLIAM COLLARD, COLLARD & ROE, P.C., 1077 NORTHERN BOULEVARD, ROSLYN, NY, 11576, US

(21) Appl. No.: 10/478,237

(22) PCT Filed: May 21, 2002
(86) PCT No.: PCT/DE02/01859

(30) Foreign Application Priority Data
May 21, 2001 (DE) 101 24 611.0

(51) Int. Cl. A01D 23/02

(52) U.S. Cl. 56/121.41

(57) ABSTRACT

The invention relates to a pruning device for removing branches from living trees, comprising a cradle with drive means and pressure means for moving the pruning device along a tree trunk and with a sawing unit which has at least one branch saw which is arranged on the cradle in a fixed or displaceable manner. According to the invention, the branch saw is embodied in the form of a circular saw, on the periphery of which are arranged exclusively non-crossed saw teeth.

The invention relates to a pruning device for removing branches from living trees according to the preamble of claim 1.

The pruning or lopping of trees, especially coniferous trees, is of major importance both for forestry and for the timber and furniture industry. Branch-free tree trunks are strived for and required for wood processing and thus it is common to remove branches and twigs from the trunks of still living trees, at least in their lower region. As a result of the pruning, a considerable increase in value is achieved because it is possible to produce branch-free sawn timber.

After pruning has taken been place, the trees, especially pine and spruce, continue to grow for many more years and increase their diameter but without the previously removed branches so that after felling these trees, the desired branch-free timber is available for furniture manufacture. In the pruning state the average diameter of the trees is of the order of magnitude of around 30 cm whereas the diameter in the final state on felling can be over 1 m. Pruning usually takes place in the lower area of the tree trunks up to a height of around 10 m above the ground.

Basically the pruning can naturally be carried out manually using a saw with which the twigs and branches can be directly removed from the trunk. However, such manual pruning is very expensive and cost-intensive. Since the pruning should be carried out up to a height of around 20 m, further aids such as ladders or the like are also required but in the most favourable case these can only reach around 10 m.

Thus, attempts have already been made to carry out mechanical pruning and in the journal “Forstarchiv”, Volume 44, Issue No. 11, November 1973, pages 237-240, a climbing saw is described for this purpose with which the branches of a tree trunk can be automatically removed. The known climbing saw comprises a cradle which grips around the tree trunk, with drive wheels which rest on the tree trunk under pressure. The drive wheels are driven by their own motor whereby the climbing saw can climb up the tree trunk up to a desired adjustable height in a spiral fashion. Arranged on the cradle is at least one commercially available motor-driven chain saw with a circumferential saw chain on a saw bar.

Known from DE 4423594 A1 is a debranching device for removing branches from living trees. As essential components the structure of the debranching device comprises an actuated, open-ended rotary rim support on which is located a likewise actuated open-ended rotary rim which is moveable relative to the positionally fixed rotary rim support. The rotary rim is moveable in such a way that it describes and circulates around an enclosed circular path so that it can thus move around the circumference of the tree trunk. An inherently known and automatically driven branch saw is located on the rotary rim. Whilst the rotary rim thus moves and describes a closed circular path, all the branches can be sawn off on the circumference of the tree trunk.

During usage of the climbing saw described in the “Forstarchiv” journal and the debranching device in accordance with DE 4423594 A1, the saw bar of the motor-driven chain saw used runs parallel and perpendicular to the tree trunk, the distance from the tree trunk being around 1-2 cm.

In this case, the chain saw goes around the tree trunk on a circular arc, whereby the branches standing in the path of the saw are not sawn off horizontally but roundedly in accordance with the circular arc.

Saw chains of conventional chain saws are constructed as sprocket chains for wood processing wherein the knives designated as cutting teeth form chain sprockets. As a result of the knives directly following one another in the circumferential direction of the chain with their laterally jutting-out knife section which projects over the chain sprockets, the side walls of the kerf are processed.

A disadvantage with chain saws constructed in this fashion is that said lateral jutting-out knife section roughens the side walls of the kerf and thus the cutting surface.

This roughening is intensified by the fact that the chain saw does, not make a rectilinear cut during pruning but executes a round cut.

However, such rough cutting surfaces of the sawn-off branches are undesirable because there is a risk of wood-destroying fungal growth. Such fungal growth can have the result that the timber quality is impaired to a high degree.

Another disadvantage with conventional chain saws is that the relatively long saw bar guided perpendicularly on the tree trunk can result in damage to the bark. This can be attributed to the fact that the tree is not exactly vertical. In the event of slight deviations, the upper end of the saw bar moves so close to the tree trunk that it touches this and cuts into the bark. In the even of such damage there is again the risk of wood-destroying and wood-damaging fungal growth.

There is also the risk that the sap flow which is important for the life of the tree and which takes place in the bark in the perpendicular direction along the tree trunk will be interrupted. This sap flow begins in the spring to a considerable extent and continues until late autumn.

On the basis of this prior art, it is the object of the present invention to provide a pruning device of the type specified initially which, having a simple structure and being easy to handle, can be used for effective and economical pruning of trees.

This object is solved with a pruning device according to the preamble of claim 1 by the characterising features of claim 1. Further developments and advantageous embodiments of the invention are obtained from the dependent claims.

The pruning device according to the invention for removing branches from living trees is characterised in that the branch saw used is constructed in the fashion of a circular saw on the periphery of which are arranged exclusively non-crossed sawteeth.

It is known from practice that circular saws are normally not suitable for making a round cut. As soon as the saw blade is guided in a circular arc around the tree trunk, in the case of conventional circular saws with crossed teeth, binding very quickly occurs during the sawing process. The binding of the saw blade is especially attributable to the crossing of the sawteeth. Crossing is understood as the mutual bending apart of the teeth. The saw cut thereby becomes broader than the saw blade whereby any binding should in fact be prevented. A circular saw constructed with crossed saw teeth also results in a very rough cutting surface which involves the risk of wood-destroying fungal growth during the pruning of trees.

Surprisingly, it has now been found that with a non-crossed saw blade guided in a circular arc, a very smooth cutting surface is obtained without any binding occurring.

According to the invention, the non-crossed sawteeth form almost a single plane with the saw blade. Such a construction of the circular saw blade is especially suitable for a round cut with a smooth surface. A circular saw blade with sawteeth jutting out from the plane, which usually prevent binding with a rectilinear cut, is unusable in this case.

It has been found to be especially advantageous that the branch saw according to the invention can operate at much higher rotational speeds compared with the motor-driven chain saws otherwise used. As a result, substantially smoother cutting surfaces are achieved.

Another advantage is that the bark of trees which do not grow exactly vertical remains undamaged because the branch saw used in the fashion of a circular saw is much shorter in its dimensions than the relatively long saw bars of the chain saws otherwise used.

The individual sawteeth of the saw blade are preferably inclined obliquely to the tree trunk on one side.

It has been found that as a result of the oblique alignment of the teeth on one side, the saw blade tends to follow the circular arc in the desired fashion during sawing off the branches

The cutting edges of the sawteeth are preferably equipped with Vidia steel, whereby the branches can be sawn off very easily.

A further development provides that the pruning device comprises at least one hydraulic line as a drive and that the sawing unit moves in an oscillating fashion at a distance from and along the circumference of the tree trunk while the cradle of the pruning device moves rectilinearly along the tree trunk.

As the pruning device advances, the sawing unit thus continuously swings horizontally from left to right about the axis of the tree trunk. It is thereby ensured that the tree trunk is pruned over the complete circumference. An oscillating sawing unit is required since a pruning device with a hydraulic drive can only be driven rectilinearly along the tree trunk because of its hydraulic connection to a hydraulic motor located on the ground. If the sawing unit climbs up the tree trunk in a spiral fashion together with the pruning device, the hydraulic line would hook onto the tree trunk from a certain height.

The cradle of the pruning device according to the invention thus climbs rectilinearly up the tree trunk wherein only the sawing unit oscillates horizontally and in this case all the branches standing in the path are sawn off over the complete circumference of the tree trunk.

The degree of one swing of the oscillation in one direction is in this case according to the invention dependent on the number and the arrangement of the circular saws used. In any case, one swing in one direction is at least sufficiently large that the total circumference of the tree trunk can be pruned.

In the case of a sawing unit which according to a further development comprises three circular saws, which are arranged at approximately the same distance from one another around the circumference of the tree, the degree of one swing about the axis of the tree trunk is around 120°.

As a further development it is provided that each saw blade of a branch saw is positioned tangentially to the circumference of the tree trunk such that the branches are cut off in the tangential direction. The branches can thereby be sawn off especially easily and close to the tree trunk.

With such an alignment of the saw blade, one half of the saw blade is closer to the tree trunk than the other half. With an oscillating sawing unit the branches are thus always at a distance from the saw blade half located closer to the tree trunk in the desired fashion. In this case, pruning takes place in a satisfactory fashion whenever the sawing unit oscillates in the direction of the saw blade half pointing towards the tree trunk. Accordingly, the pruning device will also only travel further along the tree trunk when the sawing unit has returned to its initial position.

With an oscillating sawing unit it is thus appropriate to construct the holder for each branch saw such that when the sawing unit changes from the forward to the backward movement, the branch saw can likewise be changed in its position and specifically such that the saw blade half previously at a distance from the tree trunk is now located close to the tree trunk. On changing from the backward to the forward position, the branch saw then returns to its original position and so on.

As a result of this measure it is achieved that the pruning device can climb up the tree trunk faster at the same power. In the economic respect this means that half the time is taken.

An advantageous embodiment of the invention provides that each circular saw comprises its own oil pressure motor which drives the saw blade at up to 4000 revolutions per minute.

Such a high speed results in an especially smooth cutting surface when sawing off a branch whereby the risk of wood-destroying fungal growth is substantially reduced. The use of hydraulic motors makes it possible to achieve low-wear operation of the circular saws.

A further development provides that the saw tooth division is sufficiently small that during sawing a smooth cutting surface is formed. However, the saw tooth division must be at least sufficiently large that the wood shavings accumulating during sawing can be taken up by the tooth gaps and removed.

By taking into account this further development, very smooth cut surfaces can be formed during sawing which reduce the risk of wood-destroying fungal growth.

An advantageous embodiment of the invention provides that the circular saw blade comprises at least one spacing washer pointing towards the tree trunk.

It is thereby achieved that in the event of variations in the tree trunk circumference, the sawteeth are kept away from the tree trunk, especially from the bark and do not damage this. Interruption of the sap flow in the bark necessary for the growth of the tree is prevented.

In addition, it is provided that the cutting area of the circular saw is a maximum of 10 cm.

The risk of damage to the bark is thereby also reduced. With conventionally used chain saws there was always a risk of damage to the bark from the relatively long saw bars when the tree trunks were not exactly vertical. In this case, the tip of the saw bar very easily damaged the bark of a tree trunk inclined towards the chain saw.

A further development provides that the drive and/or pressure means of the pruning device are drive chains, especially broad belts with a smooth surface.

By means of such drive chains the pressure on the bark is distributed over a relatively large area. It is thereby achieved that only a minimal bark pressure occurs and the bark is protected. The risk of interrupting the afore-mentioned sap flow in the tree trunk necessary for the life of the tree is reduced.

The drive chains preferably consist of a plastic.

Plastic is particularly suitable for protective transfer of the drive and pressure forces on to the tree trunk. In particular, the pruning device can advance even when the tree bark is wet and a high operating speed can be achieved.

In an advantageous embodiment of the invention the pruning device is a detachable section of a carrier vehicle from which the pruning device can be controlled.

The invention is explained below with reference to an exemplary embodiment which is shown in the drawings. In the FIGS.:

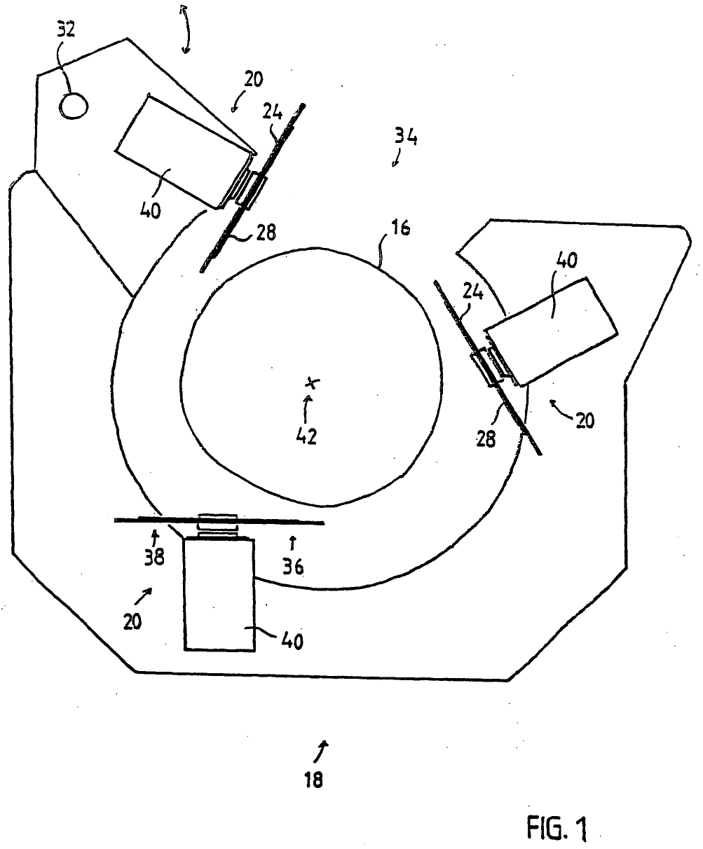

FIG. 1 is a schematic top view of a sawing unit with three branch saws,

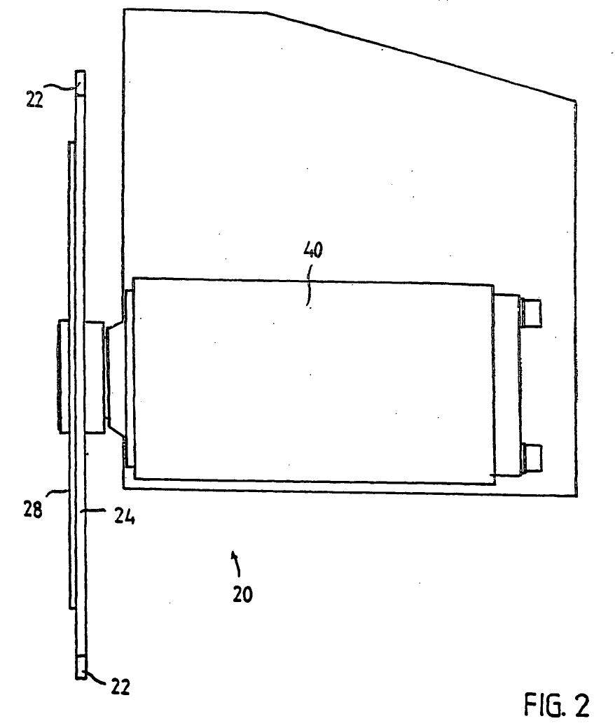

FIG. 2 is a schematic diagram of a branch saw used according to the invention in the fashion of a circular saw, shown in top view,

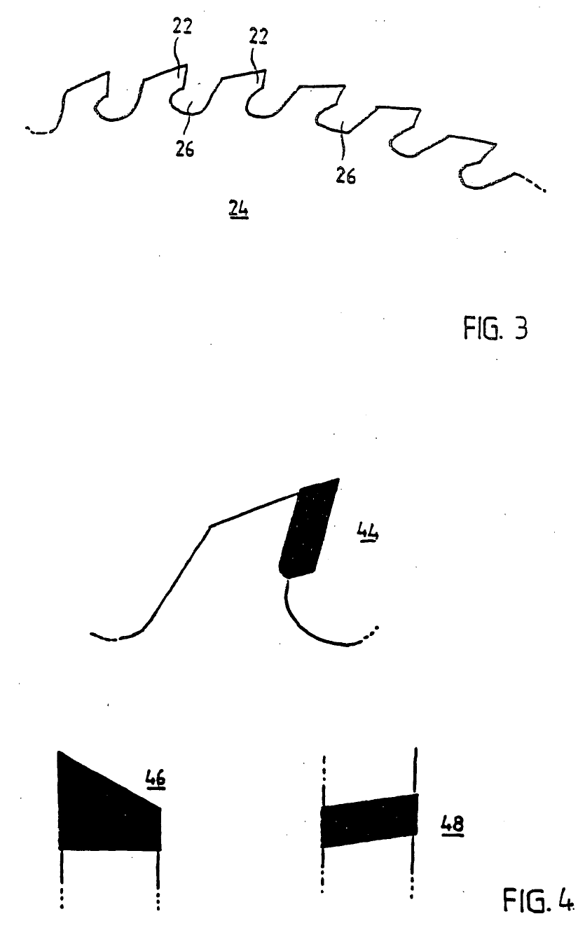

FIG. 3 is a schematic section from a saw blade used according to the invention, shown in side view,

FIG. 4 shows detailed views of a saw tooth of the saw blade used according to the invention and

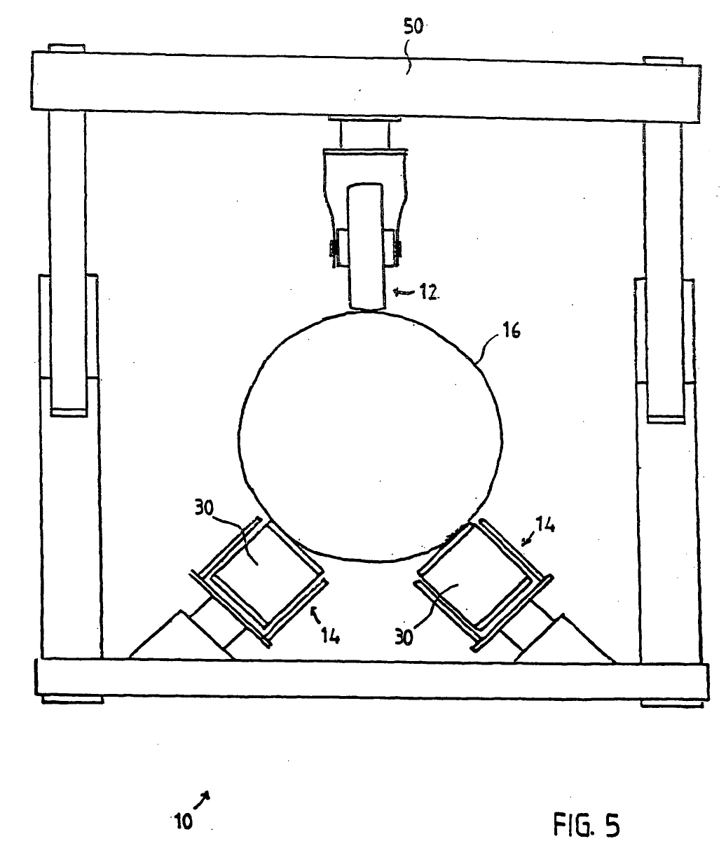

FIG. 5 shows a schematic diagram of a cradle.

FIG. 1 is a schematic diagram of a sawing unit 18 with three branch saws, each constructed in the fashion of a circular saw 20.

The sawing unit 18 is part of the pruning device according to the invention and is displaceably arranged on a cradle 10 shown in FIG. 5. The pruning device is in turn a detachable part of a carrier vehicle not shown here and is connected thereto via at least one hydraulic line not shown here. The weight of the carrier vehicle, hydraulic line and pruning device is only around 300 kg, whereby the device can be operated by one person. The carrier vehicle incorporates a four-stroke driving unit which provides the oil pressure required for itself and the drive of the pruning device.

For pruning the sawing unit 18 shown in FIG. 1 is placed around the tree trunk 16. For this purpose it may be necessary in the case of somewhat larger tree trunks 16 to fold one of the outer circular saws 20 outwards via a hinge 32 in order to thus enlarge the opening 34 of the sawing unit 18 to accommodate the tree trunk 16. Once the tree trunk 16 is positioned, the outer circular saw 20 can be brought back into its original position which can naturally be accomplished manually or automatically.

According to the invention, the sawing unit 18 shown oscillates horizontally at a distance along the circumference of the tree trunk 16 while the cradle 10 of the pruning unit shown in FIG. 5 moves rectilinearly upwards along the tree trunk 16.

The continuous horizontal oscillation of the sawing unit 18 about the axis 42 of the tree trunk 16 is especially appropriate when the pruning device is driven by means of a hydraulic line. In the case of a pruning device driven via a hydraulic line, it is not possible to drive the pruning device upwards in a spiral fashion since the hydraulic line would otherwise become hooked on the tree trunk 16. By means of the forward and backward movements of the oscillating sawing unit 18 it is nevertheless ensured that the tree trunk 16 is completely pruned. The degree of one swing in one direction is preferably around 120°.

It is furthermore shown that each saw blade 24 is positioned tangentially to the circumference of the tree trunk 16. With such an alignment of the saw blade 24 one half 36 of the saw blade 24 is located closer to the tree trunk 16 than the other half 28. With an oscillating saw blade 24 the branches are thus only at a distance from the saw blade half 36 located closer to the tree trunk 16 in the desired fashion.

Pruning always takes place satisfactorily when the sawing unit 18 oscillates in the direction of the saw blade half 36 pointing towards the tree trunk 16. Accordingly, the pruning device is also only moved further along the tree trunk 16 when the sawing unit 18 has returned to its initial position.

With an oscillating sawing unit 18, it is thus suitable to construct the holder 40 for the branch saw 20 such that the saw blade halves 36, 38 of the branch saw 20 can be alternately guided close to the tree trunk.

FIG. 2 shows a schematic diagram of a branch saw used according to the invention in the fashion of a circular saw 20, shown viewed from above.

The branch saw 20 comprises a holder 40, a saw blade 24 with saw teeth 22 driven at up to 4000 revolutions per minute and a spacing washer 28 arranged on the saw blade and pointing towards the tree trunk 16.

In addition to the use of a branch saw in the fashion of a circular saw 20 instead of a motor-driven chain saw, the pruning device according to the invention is also characterised by the fact that the sawteeth 22 of the branch saw 24 are constructed as non-crossed. Crossing is understood as the mutual bending apart of the sawteeth 22. As a result, the saw cut becomes broader than the saw blade 24. The individual sawteeth 22 are not shown in FIG. 2 but it can be clearly seen that the sawteeth 22 do not protrude beyond the saw blade 24 but almost form one plane with the saw blade 24.

As a result of the additionally arranged spacing washer 28 it is achieved that in the event of variations in the circumference of the tree trunk 16, the sawteeth 22 are kept away from the tree trunk 16, especially from the bark and do not damage this.

FIG. 3 shows a section from a saw blade 24 used according to the invention, viewed from the side.

The sawteeth 22 shown here are not crossed. The sawtooth division is selected to be sufficiently small that a smooth cut surface is formed during sawing. However, the teeth gaps 26 are sufficiently large that wood shavings accumulating during sawing are taken up by the teeth gaps 26 and can be removed.

FIG. 4 shows three detailed views of a sawtooth from a saw blade 24 of the branch saw used according to the invention.

A side view 44, a view of the tooth face 46 and a view of the tooth back 48 can be seen.

The view of the tooth face 46 shows how each saw tooth 22 is inclined obliquely on one side towards the tree trunk 16. In this diagram the tree trunk 16 would be located on the right-hand side of the tooth face 46.

Finally FIG. 5 shows a schematic view of a cradle 10 as part of the pruning device according to the invention.

The cradle 10 comprises drive and pressure means 12, 14 and ensures that the sawing unit 18 shown in FIG. 1 is moved in height on the tree trunk 16.

In this case, the pressure means 14 of the pruning device are constructed as drive chains 30 in the form of broad belts with a smooth surface.

By means of such drive chains 30 the pressure on the bark is distributed over a relative large area and the bark is protected.

At the place of usage the cradle 10 together with the sawing unit 18 shown in FIG. 1 embraces the tree trunk 16. For this purpose the cradle 10 is opened on one side 50 and then closed again. The drive chains 30 are then controlled and the cradle together with the sawing unit 18 shown in FIG. 1 becomes detached from a carrier vehicle not shown here.

The pruning device is operated by a person from the carrier vehicle, the pruning device being connected to the carrier vehicle via a hydraulic line which rolls itself up and unrolls itself.

The advance of the drive chains 30 which adhere securely even when the tree bark is wet, can be controlled continuously from the carrier vehicle and various operating speeds can be achieved. This ensures that the sawing unit 18 operates problem-free with regard to the branch thickness to be sawn. After the tree trunk 16 has been pruned, the pruning device is moved down and coupled onto the carrier vehicle again.

Practice has shown that tree trunks 16 having a diameter of 12 to 35 cm can be pruned up to a pruning height of 20 m. In this case, the branch thickness can be up to 7 cm. The special sawing technique according to the invention produces an extraordinarily clean cutting surface.

In addition, by using the pruning device according to the invention it is possible to prune 25 to 30 trees per hour at a pruning height of 10 m. Such fast pruning results in enormous economic savings. In particular, only one person is required to operate the pruning device according to the invention which can be attributed to the low weight of the pruning device and its wear-free and simple handling.

1. A pruning device for removing branches from living trees with a cradle (10) comprising drive means and pressure means (12, 14) for moving the pruning device along a tree trunk (16), and with a sawing unit (18) which has at least one branch saw which is arranged on the cradle (10 in a fixed or displaceable manner, characterised in that the branch saw (20) is constructed in the form of a circular saw on the periphery of which are arranged exclusively non-crossed sawteeth (22).

2. The pruning device according to claim 1, characterised in that on one side the sawteeth (22) are inclined obliquely to the tree trunk (16).

3. The pruning device according to claim 1 or claim 2, characterised in that the cutting edges of the sawteeth are equipped with Vidia steel.

4. The pruning device according to claim 1 any one of claims 1 to 3, characterised in that the pruning device comprises at least one hydraulic line as drive and that the sawing unit (18) moves in an oscillating fashion at a distance from and along the circumference of the tree trunk (16), while the cradle (10) of the pruning device moves rectilinearly along the tree trunk (16).

5. The pruning device according to claim 4, characterised in that the degree of one swing of the oscillation in one direction depends on the number and the arrangement of the circular saws used (20) and is at least sufficiently large that the total circumference of the tree trunk (16) can be pruned.

6. The pruning device according to claim 4 or claim 5, characterised in that the sawing unit (18) comprises three circular saws (20) and the degree of one swing along the circumference of the tree trunk (16) is around 120°.

7. The pruning device according to claim 1 any one of claims 1 to 6, characterised in that the saw blade (24) of the branch saw stands tangentially to the circumference of the tree trunk (16) such that the branches are cut off in the tangential direction.

8. The pruning device according to claim 1 any one of claims 1 to 7, characterised in that each circular saw (20) comprises its own oil pressure motor which drives the saw blade (24) up to 4000 revolutions per minute.

9. The pruning device according to claim 1 any one of claims 1 to 8, characterised in that the sawtooth division is sufficiently small that during sawing a smooth cut surface is formed but is sufficiently large that the wood shavings produced during sawing can be received by the teeth gaps (26) and removed.

10. The pruning device according to claim 1 any one of claims 1 to 9, characterised in that the saw blade (24) comprises at least one spacing washer (28) pointing towards the tree trunk (16).

11. The pruning device according to claim 1 any one of claims 1 to 10, characterised in that the cutting area of the circular saw (20) is a maximum of 10 cm.

12. The pruning device according to claim 1 any one of claims 1 to 11, characterised in that the drive and/or pressure means are drive chains (30), especially broad belts with a smooth surface.

13. The pruning device according to claim 12, characterised in that the drive chains (30) are made of plastic.

14. The pruning device according to claim 1 any one of claims 1 to 13, characterised in that the pruning device is a detachable part of a carrier vehicle from which the pruning device can be controlled.
